(19) United States
(12) Patent Application Publication
(10) Pub. No.: US 2014/0108269 A1
(43) Pub. Date: Apr. 17, 2014

(54) Collaborative Engineering Support

(71) Applicants: Theo Dirk Meijler, Dresden (DE); Olena Kutsenko, Dresden (DE); Benjamin Heilbrunn, Dresden (DE)

(72) Inventors: Theo Dirk Meijler, Dresden (DE); Olena Kutsenko, Dresden (DE); Benjamin Heilbrunn, Dresden (DE)

(21) Appl. No.: 14/054,541

(22) Filed: Oct. 15, 2013

Related U.S. Application Data
(60) Provisional application No. 61/714,044, filed on Oct. 15, 2012.

(51) Int. Cl. G06Q 10/10

(52) U.S. Cl. CPC G06Q 10/103
USPC 705/301

(57) ABSTRACT

In some implementations, supporting engineering collaboration includes actions of receiving first user input from a first partner, the first user input defining a project structure of a collaborative engineering project, the project structure including project elements, each having an embedded process that supports data sharing and process-based collaboration between partners, receiving second user input from the first partner, the second user input indicating delegation of a project element to a second partner, the project element having associated data, wherein: during performance of the project element by the second partner, versions of the associated data are automatically created based on a respective embedded process, the versions of the associated data being controlled by the second partner, and, upon completion of the project element, a version of the associated data is merged with a parent version of the associated data that is controlled by the first partner.

### CROSS-REFERENCE TO RELATED APPLICATIONS

This application claims priority to U.S. Provisional App. No. 61/714,044 filed on Oct. 15, 2012, the disclosure of which is expressly incorporated herein by reference in its entirety.

### BACKGROUND

While collaborative engineering in outsourcing projects presents potential benefits to the partners, collaborative engineering involves some risks and reasonable concerns. For example, a poor mechanism of data exchange and data communication can lead to loss of effectiveness and efficiency of the project. As another example, collaborative engineering requires partners to adapt a common business process, which often means moving away from a familiar way of working.

### SUMMARY

Implementations of the present disclosure include computer-implemented methods for supporting collaborative engineering projects including a plurality of partners that collaborate based on a plurality of artifacts, the artifacts being usable to provide constricted process visibility and constricted data sharing as between partners of the plurality of partners.

In some implementations, actions include receiving first user input from a first partner, the first user input defining a project structure of a collaborative engineering project, the project structure including project elements, each project element having an embedded process therein that supports data sharing and process-based collaboration between partners, and receiving second user input from the first partner, the second user input indicating delegation of a project element to a second partner, the project element having associated data, wherein: during performance of the project element by the second partner, one or more versions of the associated data are automatically created based on a respective embedded process, the one or more versions of the associated data being controlled by the second partner, and, upon completion of the project element, a version of the associated data is merged with a parent version of the associated data, the parent version of the associated data being controlled by the first partner.

In some implementations, in response to receiving the second user input indicating delegation of the project element, automatically copying the parent version of the associated data to provide an initial version of the associated data based on the respective embedded process, the parent version of the associated data being controlled by the first partner, and the initial version of the associated data being controlled by the second partner.

In some implementations, in response to completion of the project element, the second partner publishes the version of the associated data.

In some implementations, during performance of the project element, the version of the associated data is automatically created based on the respective embedded process and replaces a previous version of the associated data.

In some implementations, actions further include receiving third input, the third input being provided by the second partner, and providing, in response to the third input, a project, the one or more versions of the associated data being associated with the project, and the project being owned by the second partner, such that the second partner controls access to the one or more versions of the associated data.

In some implementations, the one or more versions of the associated data are stored in a data repository associated with the second partner.

In some implementations, upon completion of the project, the version of the associated data is deleted from a data repository associated with the second partner.

In some implementations, the project elements include a project, one or more sub-projects, and one or more tasks.

In some implementations, the associated data includes one or more artifacts that can be modified by the second partner.

In some implementations, the associated data includes one or more discrete data values determined by the second partner.

In some implementations, the parent version of the associated data is stored in a data repository of the first partner.

In some implementations, the project element includes a plurality of sub-elements having a hierarchical structure, wherein version data associated with a child sub-element is merged with version data associated with a parent sub-element upon completion of the child sub-element.

In some implementations, the plurality of sub-elements includes a plurality of sub-element groups, each sub-element group corresponding to a concept.

In some implementations, the plurality of sub-elements includes one or more sub-projects and one or more tasks.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIGS. 1A and 1B depict example engineering collaboration scenarios.

FIG. 2 depicts an example engineering collaboration with constricted process visibility and constricted data sharing in accordance with implementations of the present disclosure.

FIGS. 3A and 3B depict example project structures for engineering collaboration in accordance with implementations of the present disclosure.

FIGS. 4-7 depict a motivating example.

FIG. 8 depicts an example use of an embedded workflow.

FIG. 9 depicts an example extension to the example project structure of FIG. 3A.

FIG. 10 depicts another example use of an embedded workflow.

FIGS. 11-19 depict example artifacts.

FIGS. 20-22 depict example processes.

FIG. 23 depicts an example process that can be executed in accordance with implementations of the present disclosure.

FIG. 24 is a schematic illustration of example computer systems that can be used to execute implementations of the present disclosure.

Like reference symbols in the various drawings indicate like elements.

### DETAILED DESCRIPTION

Implementations of the present disclosure extend implementations disclosed in U.S. application Ser. No. 13/235,627, filed on Sep. 19, 2011 (SAP Ref. No. 2011P00206US), the disclosure of which is expressly incorporated herein by reference in the entirety for all purposes. In general, implementations of the present disclosure build on support for collaborative projects with long-term processes (e.g., logistics). In some examples, such collaborative projects can include a flexible process that can be changed in an ad-hoc manner, partners that can be ad-hoc invited and bound to certain roles in the collaborative project, and partners can have share relevant data of the collaborative project (i.e., shared data).

Implementations of the present disclosure are generally directed to engineering collaborations, in which partners collaborate to provide at least one engineering artifact. In some examples, the at least one engineering artifact can include a data set. In some examples, engineering artifacts are provided through the creation of designs and the corresponding implementations. Consequently, deliverables of the collaborative work can be provided in the form of large engineering data sets. Implementations of the present disclosure address how and in which manner to provide a middle ground between complete process visibility and process invisibility between partners. This is referred to as constricted process visibility within the present disclosure. Implementations of the present disclosure also address how and in which manner to provide a middle ground between complete data sharing and no sharing data sharing at all. This is referred to as constricted data sharing within the present disclosure. Implementations of the present disclosure further address how and in which manner, to support controlled iterations, such that changes are only carried through when accepted by all partners, and to support a form of data versioning that is fundamentally linked with such iterations.

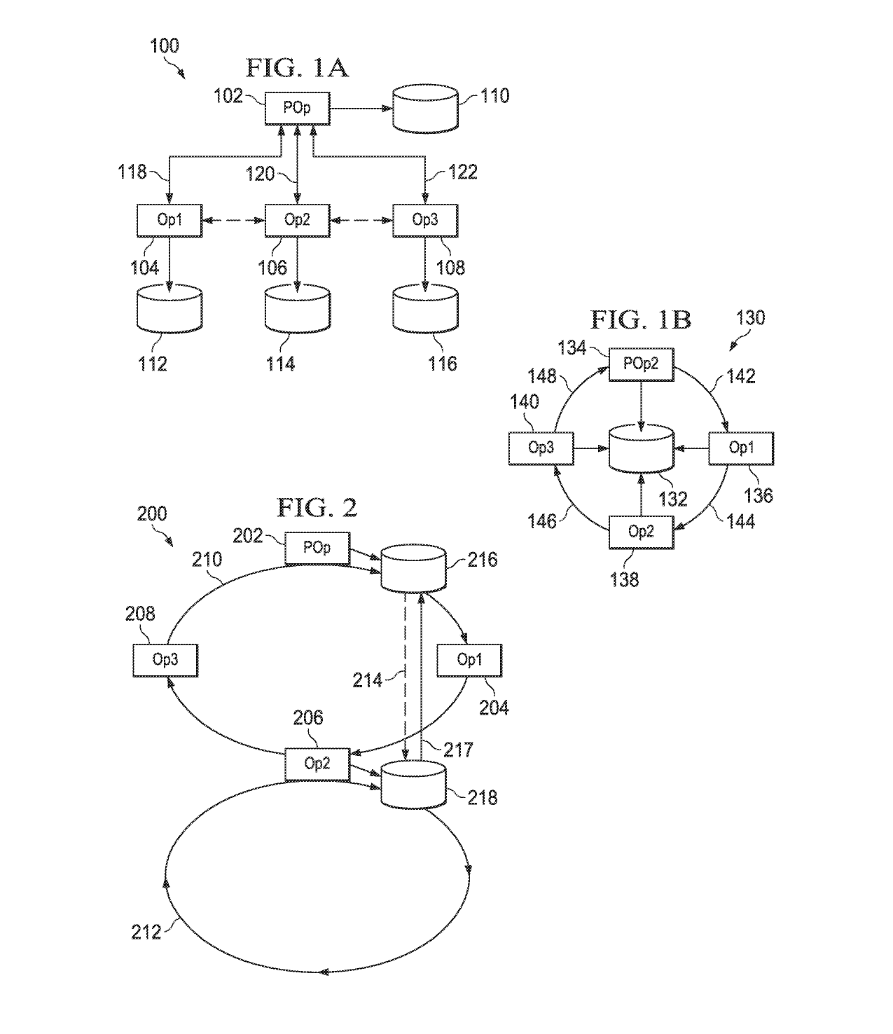

Implementations of the present disclosure will be described in further detail herein within an example context of example forms of engineering collaborations. More specifically, and with reference to FIGS. 1A and 1B, relatively simple (“naïve”) forms of engineering collaborations are provided, one presenting the most common form of current collaboration, the other a form of collaboration that is also often used. In view of this context, the present disclosure provides collaboration requirements of constricted process visibility and constricted data sharing, controlled iterations and iteration based versioning. It is appreciated, however, that the example forms of engineering collaborations provide the example context within which implementations of the present disclosure are discussed. Implementations of the present disclosure are readily applicable in other contexts with other forms of engineering collaboration.

FIG. 1A depicts an example form 100 of engineering collaboration between engineering organizations. The example form 100 is purely based on communication. Operations on engineering data are represented as shaded, rounded rectangles 102, 104, 106, 108, and the engineering data are represented as data repositories 110, 112, 114, 116. Each shade represents a different partner (e.g., engineering organization) doing the work. The operation 102 “POp” is the parent operation, which is implemented by different organizations using the operations 104 “Op1,” 106 “Op2” and 108 “Op3.” Accordingly, the engineering organizations respectively performing operations 104 “Op1,” 106 “Op2” and 108 “Op3” can be referred to as suppliers, while the engineering organization performing the operation 102 “POp” can be referred to as a customer. In the example of FIG. 1A, each engineering organization is depicted as owning its own data. In order to collaborate, data and major notifications are exchanged by means of some communication mechanism (e.g., depicted as double headed arrows 118, 120, 122). In some examples, advanced mechanisms can be used for data exchange, such as engineering data exchange tools (e.g., PDTec's tool “ICE.net”). In some examples, less advanced mechanisms can be used (e.g., e-mail).

Communication based collaboration as represented in FIG. 1A presents the most common form of engineering collaboration currently implemented. An example issue for this form of engineering collaboration includes that there is no visibility of the process. For example, a first partner that performs the operation 104 “Op1” and a second partner that performs the operation 106 “Op2” can work together to solve something for a third partner that performs the operation 108 “Op3.” However, the third partner is unaware of the status of the joint work. Another example issue includes that there is no agility of the process. Continuing with the example above, the overall partner (e.g., the customer that performs the operation 102 “POp”) is unable to easily adapt the process, thus requiring an extra partner to control the results of the first partner and the second partner. Another example issue includes that, given that some data exchange mechanisms are applied, each group of partners needs to solve this again and again between themselves. Another example issue includes that, when communication is achieved through e-mail, it can be very difficult to keep data synchronized with the communication. In view of at least these example issues, process-based collaboration with data sharing becomes an interesting alternative.

FIG. 1B depicts an example form 130 of process-based collaboration with data sharing, where partners share the engineering data. In FIG. 1B, the data repository 132 represents the shared data set, and the shaded, rounded rectangles represent operations 134, 136, 138, 140 where each shade represents a different partner doing the operation and the arrows between operations represents the sequence of operations. The operation 134 “POp” is the parent operation, implemented by the operations 136 “Op1,” 138 “Op2” and 140 “Op3.” The arrows 142, 144, 146, 148 represent that there is an explicitly defined process. This means that there is an explicitly defined sequence of the operations, and that the operations are also coordinated on the basis of this process. For example, when the operation 136 “Op1” is finished, the next partner gets an action item to perform the operation 138 “Op2.” The process can be defined by the customer, for example.

The example of FIG. 1B suggests a cyclical/iterative process. The fact that processes may be iterative, especially due to required improvements on the results, is an important observation. In practice, the number of cycles will not be infinite, there may even be only one cycle. Further, the following characteristics can be assumed to be true for the collaboration approach of FIG. 1B: access rights to the shared data can be controlled (e.g., using access control lists), the shared data can be versioned, by means of which history of changes can be tracked and compared, and the process status is principally visible to all partners in as far as relevant.

The example form 130 of FIG. 1B can solve above-discussed issues of the example form 100 of FIG. 1A. However, the example form 130 of FIG. 1B introduces other issues. An example issue can include that each partner can directly see all changes of the other partner. This can be problematic in situations where one partner is the customer of another partner, and the other partner (“supplier”) may want to hide some of its work and changes to the customer. Another example issue can include that all processes are potentially visible. In general, processes of suppliers (e.g., how it collaborates with its suppliers) should not be visible to the customer. Another example issue includes that changes are potentially uncontrolled. That is, for example, a change would not need to be agreed upon by other partners, which can result in surprises and/or conflicts. As an example, if the customer wants to request a change of the specification, this change must be accepted by the supplier (e.g., leading to increased cost of the engineering work) before it is carried out. Another example issue includes that, if each operation leads to a new version of the data, there is no explicitly maintained link between the iteration and the history of versions. That is, each iteration leads to new essential changes (as a comparison is needed between what happened in the previous iteration and what happened in this iteration), but a standard versioning does not make this distinction between such essential (iteration-based) changes and other, non-essential changes.

In view of the issues associated with the example forms of FIGS. 1A and 1B, implementations of the present disclosure provide an improved engineering collaboration approach based on collaboration requirements of: constricted process visibility (R1), constricted data visibility and sharing for delegation (R2), constricted data visibility and sharing between partners (R3), iteration-based versioning (R4), and process-controlled versioning and copying (R5). As discussed in further detail herein, the example collaboration requirements build an explicitly selected middle ground between the approaches of collaboration through communication (FIG. 1A) and process-based collaboration by data sharing (FIG. 1B).

With regard to constricted process visibility (R1), and in accordance with implementations of the present disclosure, the customer can (ad-hoc) define and see the status of the processes of its collaboration with its suppliers, and suppliers are synchronized according to the processes. Further, suppliers can also see, in as far the customer wants this, the status of the process. However, a customer does not need to see how the supplier works together with its suppliers and how it does its internal processes. With regard to constricted data visibility and sharing for delegation (R2), and in accordance with implementations of the present disclosure, a “delegator” can assign a task to a “delegatee” (e.g., another person or team). In some examples, the delegatee can be provided access to the corresponding relevant data. However, the delegatee must be able to work on its own version of the data, so that experimentation is possible, and results are only visible to the delegator when the results are considered mature. For example, the delegate can make the results available to the delegator. With regard to constricted data visibility and sharing between partners (R3), and in accordance with implementations of the present disclosure, a customer, for example, can assign a task to another partner (e.g., a supplier). In some examples, the customer can share corresponding data with the supplier (e.g., based on access rights assigned by the customer). In some examples, suppliers are able to work locally to create results, create their own intermediate data (which the suppliers can share at will), and explicitly transfer the results back to the requesting partner. With regard to iteration-based versioning (R4), and in accordance with implementations of the present disclosure, iterations, as they result in changes, can be explicitly linked to corresponding versions, such that results from iterations can be compared with each other, or the process can reuse, when needed, status information from a previous iteration.

The collaboration requirements (R1)-(R4), discussed above, are based on the provision of process-controlled versioning and copying (R5). With respect to process-controlled versioning and copying (R5), and in accordance with implementations of the present disclosure, processes can require copies and versions of data (e.g., copies are created for delegation between partners, versions are created for internal delegation and also when iterations take place). In some examples, the end-user need not know how and when such copies and versions are created, and the mechanism can be automatic. Accordingly, implementations of the present disclosure provide process-controlled, thus automatic, creation of versions and copies. In some examples, the term automatic indicates lack of user-input and/or intervention being required. In some examples, the term automatic indicates performance without user-input and/or intervention.

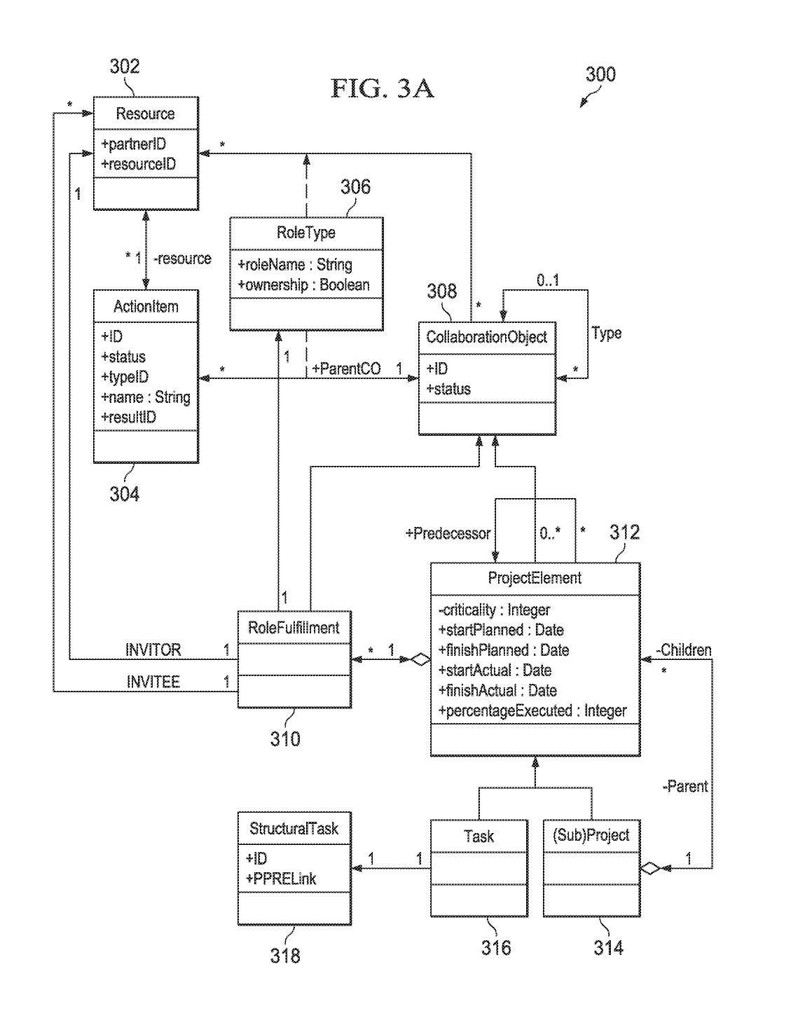

FIG. 2 depicts an example form 200 of engineering collaboration with constricted process visibility and constricted data visibility in accordance with implementations of the present disclosure. As depicted in FIG. 2, a parent operation 202 “POp” is implemented by means of operations 204 “Op1,” 206 “Op2,” and 208 “Op3” (e.g., performed by suppliers). In some examples, the process is cyclic as indicated by the upper oval 210 with arrows. A customer, who performs the operation 202 “POp,” sees the process and status of the operations “Op1,” . . . , “Op2,” for example, but does not see the status of the process (the lower oval 212 with arrows) that is managed by a partner (e.g., supplier) that is responsible for the operation 206 “Op2.” The customer that performs the operation 202 “POp” has provided constricted and clearly defined access to the relevant data to the partner that performs the operation 206 “Op2,” which is indicated by the dashed large arrow 214 from a data repository 216 that stores data associated with the operation 202 “POp” to a data repository 218 that stores data associated with the operation 206 “Op2.” The customer, however, has no visibility of the “local” data for the operation 206 “Op2,” unless the supplier explicitly transfers the result, as indicated by the large (non-dashed) arrow 217 from the data repository 218 to the data repository 216. The approach discussed above with reference to FIG. 2 is applicable to the operation 206 “Op2.” That is, the supplier performing the operation 206 “Op2” can again share data and processes at will with its suppliers.

As discussed in further detail herein, implementations of the present disclosure provide project structures with embedded workflows, simple delegation, decoupling of project ownership and project sharing, project-to-partner delegation, constricted data visibility for project delegation (both simple delegation and project-to-partner delegation), iteration-based versioning, and process-controlled versioning. In some examples, the project structures provide the basis for both data sharing and process-based collaboration. In some examples, simple delegation enables a resource (e.g., team, person, partner organization) to take over the responsibility for executing a project, a sub-project and/or a task. The decoupling between project ownership and project sharing enables organizations to own projects, but still enable other partners to do work on the projects. In some examples, project-to-partner delegation enables partners (e.g., external partners) to create their own projects in order to handle their responsibility for a specific task owned by a delegating partner. In some examples, process-controlled versioning supports integration between project delegation or project iteration and the corresponding data handling.

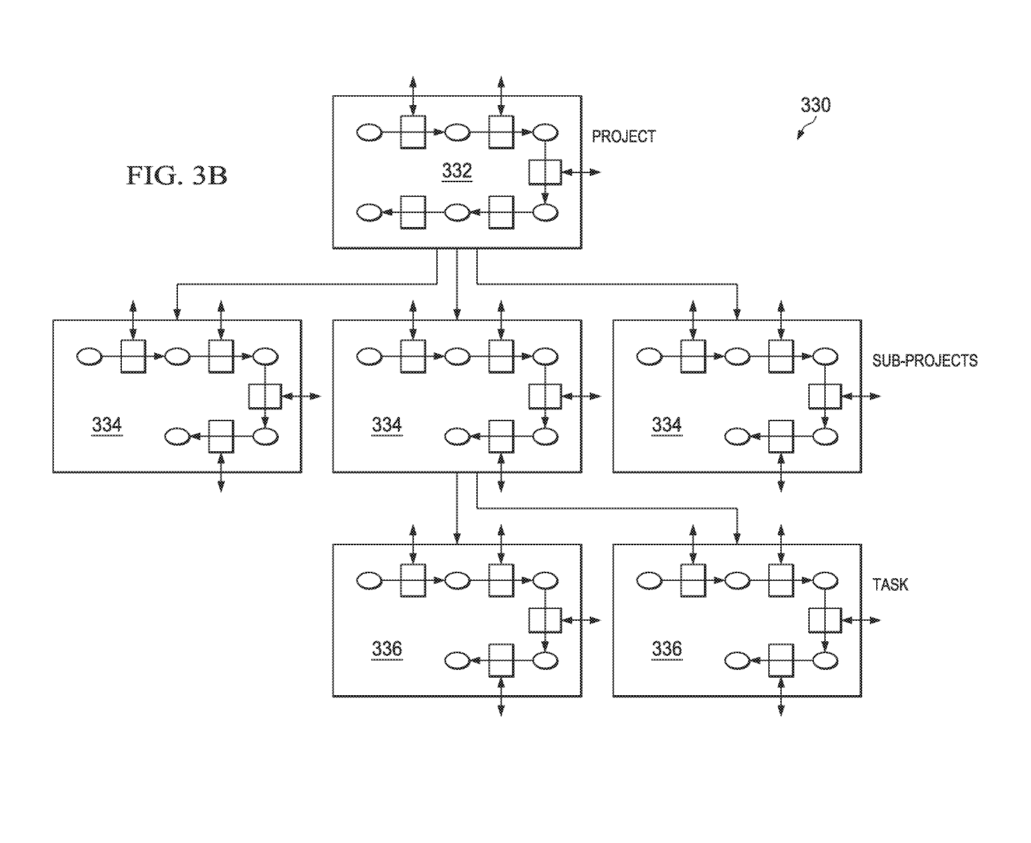

FIGS. 3A and 3B depict example project structures for engineering collaboration in accordance with implementations of the present disclosure. In some implementations, collaborative processes are described/executed in terms of project structures.

With particular reference to FIG. 3A, an example detailed project structure 300 is provided. In some examples, the example project structure 300 can be defined using a modeling language (e.g., the unified modeling language (UML)) and can be stored as an electronic file. In the example of FIG. 3A, the example project structure 300 includes resources 302, action items 304, role types 306, collaboration objects 308, role fulfillments 310, project elements 312, sub-projects 314, tasks 316, and structural tasks 318.

FIG. 3B depicts an example high-level project structure 330. As depicted in FIG. 3B, an example project structure 330 can include a project 332, sub-projects 334, and tasks 336. In some examples, each of the project 332, sub-project 334, and 336 task can be referred to as “project elements.” In some examples, partners can be ad-hoc invited to participate in the collaboration and can be bound to certain roles in the collaboration process. In some examples, each project element has an associated lifecycle that describes the workflow of executing the particular project element. In some examples, each step in the lifecycle leads to the creation of so-called “action items” that are sent to partners to perform. In some examples, the possible ad-hoc composition of such project structures can be done by a project manager as part of the execution of a project planning action item.

In view of FIGS. 3A and 3B, and in accordance with implementations of the present disclosure, partner collaborations can be coordinated in terms of collaboration objects. In some implementations, relevant collaboration objects in the domain of engineering collaboration can be provided as project elements. In some examples, project elements can include projects (e.g., engineering projects), sub-projects and tasks (as depicted in FIG. 3B). In some implementations, relevant collaboration objects in the domain of engineering collaboration can be provided as role fulfillments. In some examples, a role fulfillment is used to coordinate the process of inviting a certain partner to a role.

In accordance with implementations of the present disclosure, collaboration objects include an embedded process (e.g., workflow). In some examples, an embedded process includes a sequence of action items. In some examples, partners (e.g., engineers) are required to take an action based on a respective role that they play in the collaboration object. In some examples, a partner is notified of the action item to be performed, and provides a response when the action item is completed. Example action items for a project element can include: plan project (e.g., in terms of sub-projects and tasks), select resources, execute sub-project, execute task, validate sub-project results, and validate task results. As indicated by the above-provided example action items, action items need not be specific for the purpose of the work at hand, because the purpose of the work at hand is typically expressed in terms of the projects and tasks (e.g., design a mold for a plastic injection molding process), while the action item, and therefore the corresponding embedded workflow process describes the (generic) lifecycle of such a task or sub-project.

In some implementations, synchronization points are provided. In some examples, a synchronization point indicates a point where the embedded workflow of one collaboration object waits for a status change in another collaboration object. In some examples, synchronization points enable project structures to be ad-hoc planned and changed during execution of processes. In some implementations, internal data structures are provided. In some examples, internal data structures enable collaboration objects to refer to the relevant data at hand. For example, and with reference to the example of FIG. 3A, engineering data can be stored externally (e.g., in a data repository), and the data can identified within the structural task (e.g., by “PPRELink”).

In some implementations, simple delegation can be provided through the selection of resources. In some examples, simple delegation enables a project element to be delegated to a specific resource, the resource taking over the responsibility for execution of that project element.

As noted above, implementations of the present disclosure provide decoupling of project ownership from project sharing. In some implementations, a collaboration object (e.g., project-element, role-fulfillment) has a clear owner. For example, a role in a set of defined roles corresponds to the ownership of the project. In FIG. 3A, this is represented by the “ownership” Boolean property of a RoleType. In some implementations, through role-fulfillments, the owning partner can invite partners to play a certain role on the collaboration object. On basis of the respective role, the partner is provided certain access and visibility rights on the collaboration object. Maximally, the partner can see the full status of the collaboration object. In some examples, and on the basis of the respective role, a partner does not only get controlled access to the project element, but also to the related data. In other words, each collaboration object is owned by a certain partner, and can be shared “at will” with other partners on basis of respective roles. Accordingly, decoupling of project ownership and project sharing plays an important role in fulfilling constricted process visibility (R1). More specifically, it is the project that represents the process, and through project ownership partners can share or hide parts of this at will to other partners.

As discussed in further detail herein, constricted process visibility (R1) can be fulfilled through delegation. In some examples, the customer delegates a task to a supplier. Upon acceptance of the task, the supplier has access to the initial instructions and receives access to the relevant data. The supplier can create a project based on the task and structure it accordingly. The details of the project work are invisible to the customer, in as far as the customer has limited (or no) read access to the project structure of the supplier. In some examples, constricted data sharing can be provided in a scenario where the supplier accepts a task assigned by the customer, and receives access to references to initial data. In some examples, a placeholder for the output results is made available to the supplier. The supplier uses input data for executing the task and copies the results into the output placeholder once the task is finished. Intermediate data of the supplier is invisible to the customer unless the supplier explicitly gives corresponding access rights to the customer (e.g., in order to request an approval of or feedback on the intermediate results).

As discussed above, each project element has an associated lifecycle. Through this lifecycle, controlled iterations can be realized. In some implementations, two main cases can be provided. In a first case, the results (outputs) of a project element (task, sub-project, project) can be determined to be insufficient (e.g., unsatisfactory, incomplete), resulting in an iteration. In this case, the lifecycle of the project element contains a separate result approval transition, where an action item is sent to a partner (this can be a project manager, or also the client), to approve the result. If the result is not approved, the lifecycle continues in iteration. In a second case, inputs to the project element are to be changed. Consequently, an iteration is performed. For this case, the lifecycle of the project element contains separate possible transitions, where the customer of the project element can propose an input data change, and in a subsequent transition, the supplier (providing the results of the project element) can approve. Only after approval is provided is the change executed, and the lifecycle continues in iteration. In case a task has an associated project, an agreed upon change on the owning task results in a message to the associated project, which then also continues in iteration. With regard to iteration-based versioning, and as discussed above, any iteration can be performed on the basis of disapproval/change action items. In case an extra iteration is needed for a project element, a new “essential” version can be created. This is handled by the corresponding lifecycle transition of the project element.

Implementations of the present disclosure are discussed in further detail below. Further detail of implementations of the present disclosure are provided in “Integrated Versioning and Collaboration Process Management of Automotive Production Lines based on an Artifact-Centric Collaboration Environment,” by Olena Kutsenko, submitted as a Masters Thesis to Universidad Politecnica de Madrid, Madrid, Spain (the “Masters Thesis”). The Masters Thesis is annexed hereto and is expressly incorporated herein by reference in the entirety for all purposes.

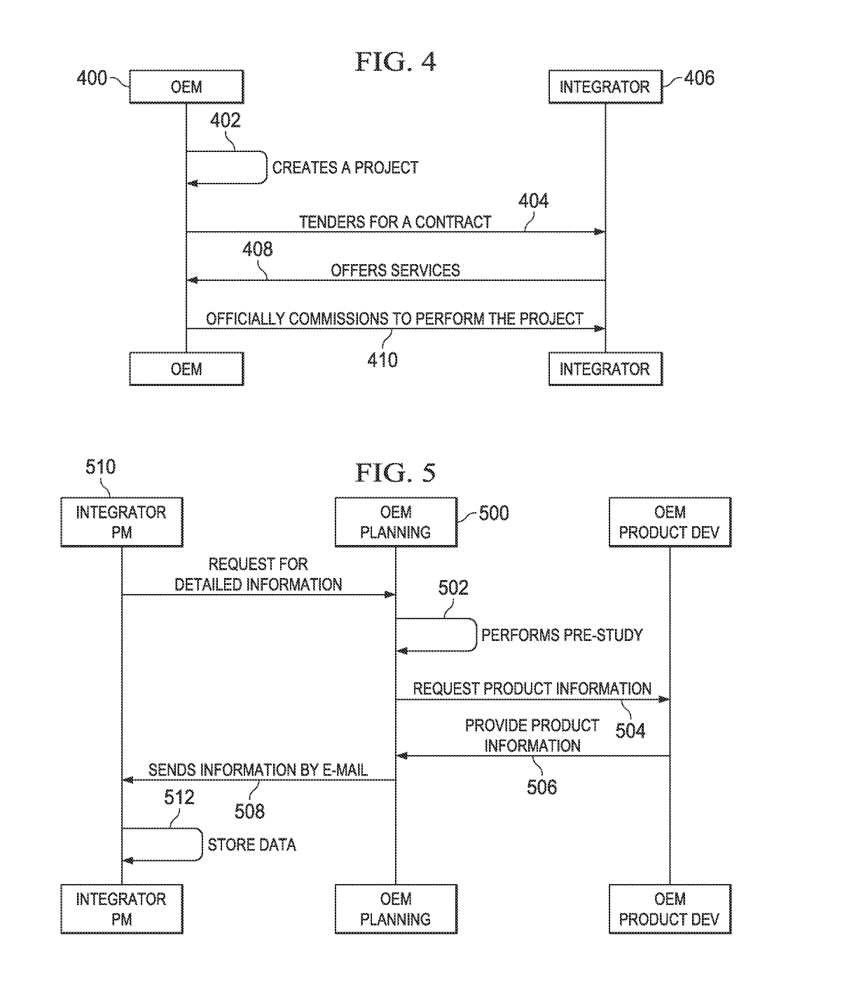

Referring now to FIGS. 4-7, a motivating example will be discussed. While implementations of the present disclosure can be applied to the motivating example, as discussed in further detail herein, implementations of the present disclosure can also be applied in other examples, not specifically addressed herein.

The motivating example discussed herein includes processes used in production development of automotive industry when several partners collaborate in order to achieve a common aim. The scenario of the motivating example focuses on several general steps used by companies in manufacturing design and development. The main actors and their roles in these processes are discussed in further detail below. The source of information is a company, which tries to improve the efficiency of their work by improving the collaborative approach they use with partner organizations.

In the motivating example, two main actors are provided as large corporations, and two groups of small actors with limited tasks and responsibilities are provided. In the motivating example, an original equipment manufacturer (OEM) is provided and includes an organization whose goal is to design and manufacture a vehicle. The OEM is responsible for formulating main requirements, purchasing, planning, and producing the final results. However, due to the complexity and the size of the work, part of the work performed by the OEM is often delegated to one or more other companies. In this case, the OEM defines tasks and sets deadlines. For purposes of illustration, discussed below, an Organization A is an OEM.

A system integrator (Integrator) can be provided and can include a company that takes responsibility for performing work delegated by the OEM. In some examples, the Integrator provides knowledge and experience in implementing complex automation solutions. The Integrator follows the OEM requirements and helps achieve the OEM's goals. For purposes of illustration, discussed below, an Organization B is an Integrator. A supplier is responsible for delivering equipment and other goods, either from the OEM-side or from the Integrator-side. Engineers perform tasks in order to make a deliverable ready, either from the OEM side or from the integrator side.

The motivating example includes an example sequence of design activities in manufacturing. In some examples, activities can include one or more activities that are usually performed in a collaborative project between the OEM and the Integrator. These activities can describe the start of the project and the initial steps leading to the design of an assembly line, for example. This information provides an overview on the processes used by the OEM and the Integrator.

As introduced above, implementations of the present disclose provide project-to-partner delegation. In some examples, project-to-partner delegation enables a delegatee (e.g., partner) to create their own “delegated” project for handling an assignment from a delegator (e.g., partner). In this manner, the delegate can have full control on the visibility of the delegated project.

Continuing with the motivating example, the OEM wants to build a new or adapted product line. For this, the OEM can define a task (e.g., “Task Design Eq.”) to design, develop and install new equipment in the new or adapted production line. The task can be defined, because this work is not done within the OEM in this example. An Integrator (e.g., partner) is requested to design the equipment for the OEM, and receives an action item to execute the corresponding task. The Integrator creates a new project (e.g., “Project Design Eq. XY”) and links the project to the action item. The new project “Project Design Eq. XY” will be owned by the Integrator.

In accordance with implementations of the present disclosure, and through project-to-partner delegation, the delegatee (e.g., integrator) will have full control over how the results are developed, can create its own sub-projects, can invite suppliers (e.g., additional partners, and so on. Consequently, the delegatee has full control over who can be invited to do certain tasks, and with whom data can be shared. This also means that, apart from the possibility to transferring results to a customer (e.g., the OEM in the motivating example above), the delegatee can also share results of the project with the customer in a controlled manner. For example, and in the context of the motivating example provided above, the delegatee can give the OEM a role in the project “Project Design Eq. XY,” and can, for example, ask the OEM to review current results.

In general, simple delegation can be described as a delegator delegating a task to a delegatee (e.g., a resource that is internal or external to the delegator), where the delegatee is provided read-write access to a separate version of data (e.g., artifacts, data values). In general, project-to-partner delegation includes the above-described aspects of simple delegation, but the delegatee can copy the relevant data (e.g., artifacts, data values) and can create its own project, sub-projects and/or tasks. In this manner, the delegatee controls full access to the copied data, including modifications thereto. In both simple and project-to-partner delegation, once the task is completed, the separate version of the data is merged with the version of the data associated with the delegator.

In some examples, inputs and outputs of the action item can be transferred to and from the project. For example, and in the context of the example provided above, a “Spec” input of the task “Task Design Eq.” will also become input for the project “Project Design Eq. XY,” and an output “Design,” (the result of the project) can be transferred (e.g., through copying) to the OEM's task.

In some examples, and in the context of the motivating example provided above, the OEM could structure a “Production Line” design activity into several sub-projects, with each sub-project having its own tasks. The OEM can requests the Integrator to handle each of the sub-projects. In this manner, the OEM keeps stricter control on the overall project structure.

With particular reference to FIG. 4, and in some examples, the OEM 400 (e.g., an OEM Project Management department (OEM PM)) creates a project 402 and publishes the project for tendering 404, inviting other parties to make proposals. Potential Integrators 406 send 408 their proposals to the OEM, which selects 410 one or more Integrators 406.

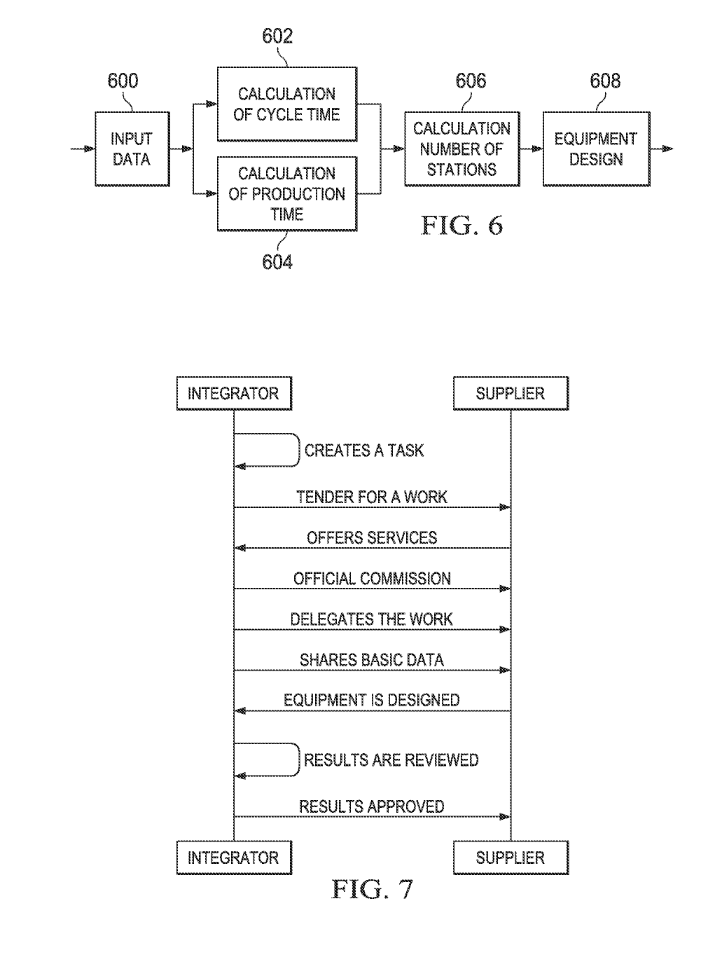

Once the OEM PM selects the Integrator(s), the project moves to a concept engineering phase. In some examples, concept engineering can include multiple phases: “Planning processes and layout” and “Planning tools and equipment.” The manufacturing processes are generally complex. In order to simplify the illustration, particular engineering tasks can be focused on. Example engineering tasks can include: input data, calculation of cycle time, calculation of production time, calculation of number of stations, and equipment design. The tasks and their order are depicted in FIG. 6.

With reference to FIG. 5, and continuing with the motivating example, the first mandatory task, which is performed by the OEM PM, is to perform a pre-study 502, acquire product information 504 and collect 506 all necessary data for the project. Once the data is available, it is shared with 508 the Integrator Project Management department (Integrator PM) 510. The Integrator PM 510 stores the data 512. Next tasks are delegated to the Integrator. Once the Integrator has input data available, the work on the delegated assignments can be started. The tasks represent operations, which are to be performed based on the data received from the OEM. In some examples, these tasks can include calculations of the parameters needed for planning activities. The Integrator PM creates tasks for engineers to perform the estimations and calculations.

In some examples, and based on previous experience, the Integrator and the OEM can already have pre-defined tools that can be used for performing the tasks. In some examples, tools vary from project to project and each tool can have more than one version. Consequently, an engineer can use one of available tools for executing the task. However, it is important to know which tool is the most appropriate for the current situation. Further, unless an engineer already has some experience in the work related to the task, the engineer can experience difficulties in finding a suitable solution. This can occur, for example, because the scope of engineer's work is normally very broad. Consequently, the engineer can be assigned unfamiliar tasks and may require assistance regarding how these tasks are best executed and what tools are preferable in a current context.

With particular reference to FIG. 6, example tasks are depicted within the context of the motivating example. After the input data is stored 600 by the Integrator, the cycle time calculation 602 and the production time calculation 604 can be performed. In some examples, these tasks can be performed in parallel (as depicted in FIG. 6). In some examples, these tasks can be performed using tools (e.g., MS Excel based tools). The calculation of the number of stations 606 can be next performed. The output data from the previous tasks is used as input parameters to this task. The last task provided in the example of FIG. 6 includes the equipment design 608. In some examples, the integrator can tender for a responsible partner to perform equipment design. When a supplier is selected, the work is assigned to the supplier and the basic data needed to perform the work is shared. Once the task is executed, the supplier delivers results to the Integrator. In some examples, the Integrator might refuse the results and can request for alternative results. In this case, the supplier can redo the work and present new results to be approved (see FIG. 7).

In some implementations, and referring again to constricted data visibility and sharing for delegation (R2), when delegating a task to a resource (e.g., some person or team, a supplier, an integrator, the resource is provided with a respective version or copy of the relevant data. In this manner, the resource is able to experiment with the data to produce results that may be tentative, and are therefore not visible to other resources (e.g., working on other tasks). In some cases, the resource involved is external to the organization that delegated the task. Consequently, and in some examples, a “sand-box” can be provided, such that the external organization cannot access the original data. In case the original data is on the delegator's internal system, and the sand-box can be provided in a de-militarized zone (DMZ).

In some examples, this principle is recursive for the project structure. For example, a project P1 can include a sub-projects SP1 and SP2. The sub-project SP1 can include tasks T11 and T12, and the sub-project SP2 can include task T21. In accordance with implementations of the present disclosure, if there are several tasks (e.g., T11 and T12) under one sub-project (e.g., SP1), the results of a task (e.g., T11) should only become visible to another task within the same project (e.g., T12), if the task (e.g., T11) “publishes” the results. Further, and in accordance with implementations of the present disclosure, the results of a sub-project (e.g., SP1) should only become visible to other sub-projects of the same project (e.g., P1) after the sub-project (e.g., SP1) publishes its results.

In some implementations, constricted data sharing for delegation (R2) is realized by means of version creation and merging. To illustrate this, a project (e.g., P) can include a sub-project (e.g., SP), which includes a plurality of tasks (e.g., T1, T2, T3). In some examples, the tasks can be provided in a sequence (e.g., T1 is performed first, and T2 and T3 can be performed in parallel). For example, and with reference to FIG. 6, the project can be provided as “Equipment design,” the sub-project can be provided as “Calculation of number of stations,” and the tasks can be provided as “Input data,” “Calculation of cycle time,” and “Calculation of production time.”

In accordance with implementations of the present disclosure, each task can write respective results in specific versions that can subsequently be merged. In some examples, tasks write results into a data structure that include objects provided as instances of a data model. For a data model can include a concept “Manufacturing System,” which is at least partially defined based on task outputs (e.g., production time, cycle time). Each lower level in the project hierarchy, in this example “Calculation of number of stations” and below that “Calculation of cycle time” and “Calculation of production time,” can be provided in respective sand-boxes for accessing and adapting its own set of data. In some examples, the sand-boxes are subsequently merged when a task or project publishes its result. For example, merging is performed when a version tree is created that mirrors the project structure. In some examples, each project element has, for each relevant element in the data structure (in this case this is only the instance of the concept “Manufacturing System”), a corresponding version. When a project element, such as the task “Calculation of cycle time” is a child of another project element, such as the sub-project “Calculation of the number of stations” a corresponding sub-version is created of the relevant data element in this case. Thus, when each of the (potentially) concurrent tasks (e.g., “Calculation of cycle time” and “Calculation of production time”) are active, a version tree is created for the instance of “Manufacturing System.” Further, when tasks write their results in these versions, the changes that they do are also recorded in the version. For example, “Calculation of cycle time” writes the new value for “cycle time,” and thus the delta is recorded on the version through the extra change element “Acycle time.” Similarly “Calculation of production time” writes a new value for “process time” as recorded through the change element “Aprocess time.” In some examples, it can be assumed that two different tasks that can run concurrently always have different goals, and the change elements will always be distinct.

In some implementations, when a project element publishes its results, the changes it has done are merged in the version corresponding to the parent project element. When the project element is finished, its corresponding sub-version can be removed. For example, when the tasks “Calculation of cycle time” and “Calculation of production time” publish their results, the changes are updated in the parent version. Principally this corresponds to a merge. Because the change elements “Acycle time” and “Aprocess time” are distinct, this merge is unproblematic. The change elements are recorded at the sub-project level. When the tasks “Calculation of cycle time” and “Calculation of production time” finish, the corresponding sub-versions can be removed. When the project element “Calculation of number of stations” publishes its results, the results are merged into the version corresponding to the “Equipment design” project.

Versioning is provided for more complex data models than that discussed above. For example, and based on the example discussed above, a data model can include the concept “Manufacturing System,” the concept “Process,” and the concept “Configuration.” In this data model, “Calculation of production time” not only writes results in the instance of the concept “Manufacturing System,” but also in the instance of the concept “Process,” and in the instance of the concept “Configuration.” In this example, “production time” can be provided as a property of the concept “Configuration” not of “Manufacturing System,” as discussed in the simpler data model provided above. As highlighted in this example of the more complex data model, the mechanism for one instance of one concept is correspondingly applied for all of the concept instances that the task accesses. In this more complex data model, “Calculation of cycle time” does not write results to instances of the concepts “Process” and “Configuration,” and only writes results to the instance of the concept “Manufacturing System.” Consequently, sub-versions for “Process” and “Configuration” do not need to be created for this task.

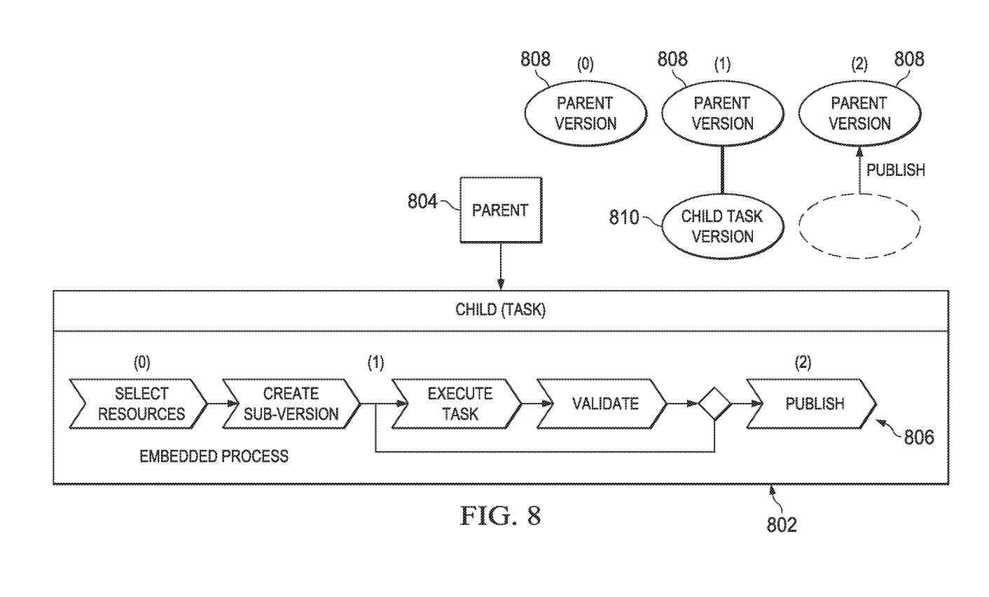

Referring now to FIG. 8, process-controlled versioning and copying (merging) (R5) will be discussed. As discussed in further detail herein, the principle of an embedded workflow process enables the automatic creation of sub-versions when a task is initiated, and subsequently the publication and merging of results. Consequently, the resources are not required to explicitly take action to create sub-versions and/or perform merging of results. In some examples, the term automatic indicates the generation, creation of provision of a sub-version without requiring user-input and/or intervention.

FIG. 8 depicts a task 802 which is the child of some parent 804. For example, the parent 804 can be provided as a sub-project. The task 802 can include an embedded process (workflow) 806. In the depicted example, workflow phases are provided and are numbered (0), (1) and (2). At the top right-hand side of FIG. 8, evolution of a version tree is provided in view of the phases. In some examples, the version tree depicts versions of data through progression of the process 806 from the perspective of the parent 804 and the task 802. Example data can include artifacts (e.g., a design document) and values (e.g., a calculated value such as cycle time, production time). In some examples, the parent version of the data can include data maintained by a partner (e.g., customer) that delegated the task 802 to another partner (e.g., supplier), while the child task version of the data can include data maintained by the other partner, which is provided to the delegating partner upon completion of the task 802, for example.

In phase (0), only the version of the data 808 corresponding to the parent exists. After selection of a resource (e.g., supplier), the resource responsible for performing the task is provided with a respective version 810. For this, the action item “Create sub-version” indeed creates a sub-version. Consequently, the phases move to phase (1) where a specific version exists for the task 802. Subsequent action items correspond to the execution of the task, and when finished, the validation is done. When the validation succeeds (e.g., the results are accepted), the changes will be published into the parent version and the child version will be removed. This is phase (2). Accordingly, the data provided in the version 810 is merged with the data provided in the version 808, and the version 810 is deleted (e.g., from a data repository associated with the resource that performed the task 802).

Referring again to constricted data visibility and sharing between partners (R3), partner-to-project delegation will be discussed in further detail. In some examples, in project-to-partner delegation, data is explicitly transferred from the project owned by the delegator to the project owned by the delegatee. In this manner, the delegatee gets full ownership of and access to the data, and thus full control over which other partner should see what, and when results are to be transferred back to the delegator. Example concepts that support this mechanism include constricted data visibility and sharing for (simple) delegation (discussed in detail above), project-on-delegation, structural tasks and overall data model, input/output relationships, and embedded workflow.

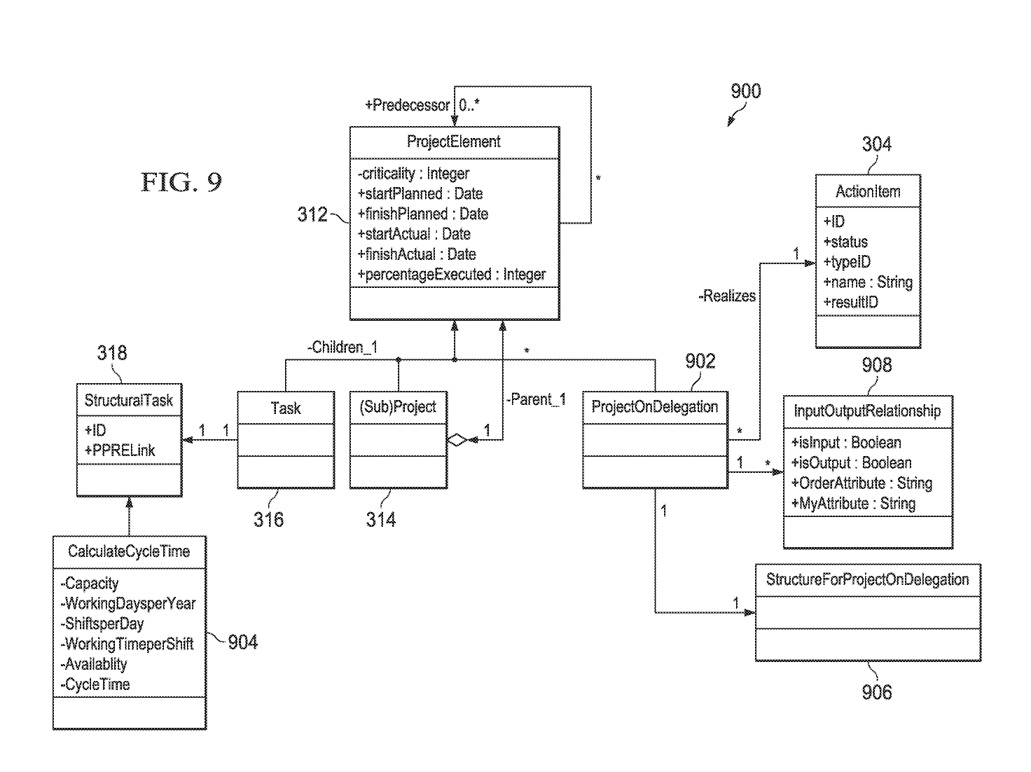

Referring now to FIG. 9, project-on-delegation, structural tasks and overall data model, input/output relationships, and embedded workflow will be discussed in further detail. In general, FIG. 9 depicts an example extension 900 to the project structure of FIG. 3A. In the depicted example, the extension 900 includes the concept “ProjectOnDelegation” 902, and introduces an example sub-class 904 of the concept “StructuralTask” 318.

In some implementations, the ProjectOnDelegation is the class of a project created by the delegatee in order to handle an action item of the delegator. In some examples, a delegated project has a relationship “Realizes” with the action item 304, for which it is performed. The action item includes a reference to the project element for which it is valid. Thus, for example, the Project “Design Eq. XY,” can be provided as an instance of “ProjectOnDelegation” and it has a “Realizes” relationship with an action item for the Task “Design Eq” of the OEM.

With continued reference to FIG. 9, tasks 316 have associated “Structural Tasks” 318. In some examples, a structural task explicitly represents the inputs and outputs of a respective task. The use of structural tasks is founded in the fact that there is an “overall data model.” For example, and example overall data model can include Manufacturing System, Process, and Configuration, as discussed by way of example above. In contrast, a task has a simple input/output model. Through the “StructuralTask,” task-specific inputs and outputs are mapped to the overall data model. Continuing with examples discussed above, and in the example of FIG. 9, the Structural Task 318 has a property CycleTime, which is seen as an explicit property of that task. The StructuralTask class implements functionality to map this property to the generic data model, for example the property CycleTime of the task “CalculateCycleTime” is mapped to the property “cycle time” of the concept “ManufacturingSystem.” Similarly, a ProjectOnDelegation object 902 has an associated StructureForProjectOnDelegation object 906 that handles the read and write of the corresponding inputs and outputs from the data model.

In the example of FIG. 9, an input/output relationship, as represented by the “InputOutputRelationship” class 906, defines how the inputs and outputs of the project-on-delegation need to be mapped onto the inputs and outputs of the task for which these data are needed, or for which they are created. For example, and based on the examples above, example instances of “InputOutputRelationship” as follows:

Relating “Spec” of the project “Design Eq. XY” with the task “Design Eq.”
isInput is true, isOutput is false (note that in some cases, results can be input as well as output)
OrderAttribute is “Spec”
MyAttribute is “Spec”

Relating “Design” of the project “Design Eq. XY” with the task “Design Eq.”
isInput is false, isOutput is true
OrderAttribute is “Design”
MyAttribute is “Design”

As similarly discussed above with respect to FIG. 8, a ProjectOnDelegation can include an embedded workflow to handle both the data retrieval as well as the data transfer back to the ordering project or task. In some examples, the embedded workflow is provided as follows: Retrieve data (this action item retrieves all data that are marked as input in the input output relationship), Plan project (this action item is used to plan the project, this action item and the following action items support internal execution of the project), other action items (e.g., plan resources, do project), and Transfer data (this action item transfers the results from the ProjectOnDelegation back to the task for which this project was ordered.

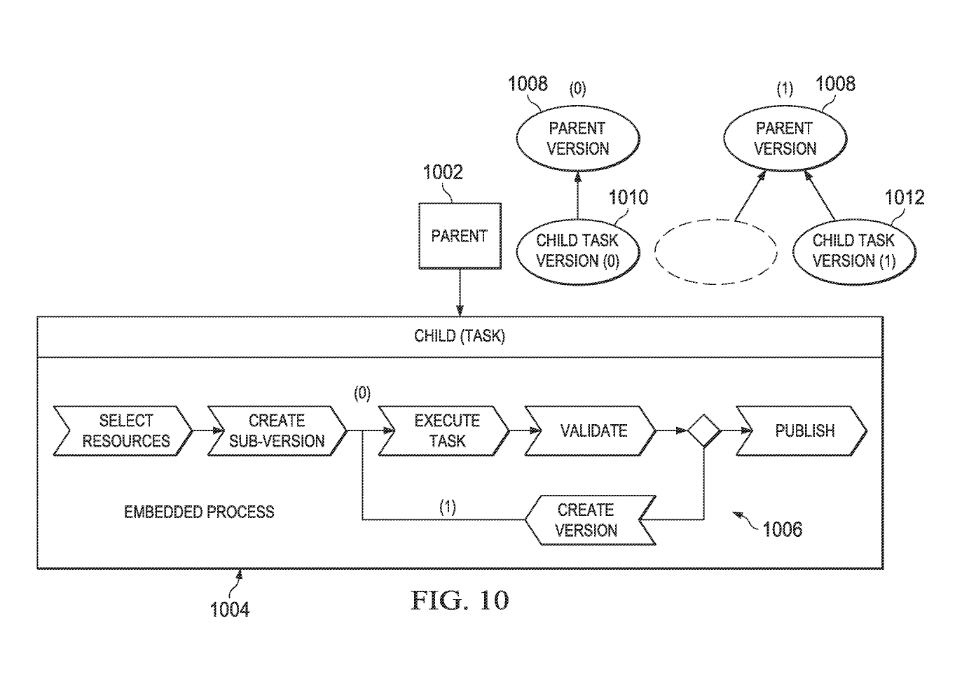

Referring now to FIG. 10, iteration-based versioning will be discussed in further detail. In accordance with implementations of the present disclosure, iteration-based versioning is the mechanism through which, when iteration is needed in the collaboration (e.g., a task or a sub-project has to be done again due to issues or change requests), a corresponding new version of the related data is automatically created. In this manner, results from iterations can be compared with each other, and/or the process can reuse, when needed, result information from a previous iteration.

With reference to FIG. 10, the automatic creation of versions will be discussed. In some examples, the term automatic indicates the generation, creation of provision of a version without requiring user-input and/or intervention. In the example of FIG. 10, a parent 1002 (e.g., a sub-project) and a child task 1004 are provided. The task 1004 includes an embedded process (workflow) 1006. FIG. 10 is similar to FIG. 8, however, FIG. 10 focuses on iteration. The workflow phases of FIG. 10 are numbered (0) and (1), and evolution of the version tree evolves through these phases is depicted. In phase (0), there is a parent version 1008 of the data one sub-version 1010 corresponding to the task-specific sand-box for working on the data. This sub-version 1010 is called “Child Task Version (0).” When, as a result of the validation, a next iteration must be performed, a special action item “Create Version” is invoked, which creates a special version 1012 for the iteration. In phase (1), this has now occurred, an extra version “Child Task Version (1)” 1012 has been created, and the “Child Task Version (0)” 1010 is removed, as it is no longer the current version.

As in many collaborative projects, issues and bottlenecks can be hindrances. In some examples, the first difficulty for this kind of project is the number of involved departments and employees, who have interconnected tasks and may be split into different branches and with different levels of expertise. Moreover, people involved in the project are employed by different companies and, to make the partnership even more complex, both the Integrator and the OEM can invite suppliers or other participants (contractors) to delegate work. In some cases, the contractors belong to various branches having their own procedures, project management systems, communication channels as well as using different organizational methodologies. In some examples, tendering is the main tool in selecting a participant. Thus, a particular contractor is might be unknown until the project is already in progress. Additionally, the number of contractors can also be unknown in advance.

Another issue can include communication channels between partners. Each partner may have a well-developed internal communication mechanism. However, when it comes to exchanging data between partners, a universal tool might not be used by the various partners. In some examples, principle mean of communication can include e-mail, fax and telephone. Such tools, however, are not suitable for tracking, storing and reusing data later. Further, using e-mail or fax to exchange documents, for example, often leads to discrepancy between data versions owned by partners, because a document can be modified by different actors and stored in different formats. Consequently, a work overhead is provided to keep the partners updated with the last version of documents.

Another obstacle that slows down project planning and execution can include keeping project managers of the Integrator and the OEM up-to-date about the state of tasks and next actions. This can be attributed to physical remoteness of involved collaborators. Planning activities of the project between partners may also be complicated, because of different processes each partner adapts. In some examples, finding a common unified approach takes time and does not always go smoothly.

In view of the foregoing, the following issues can remain as bottlenecks to the motivating example: lack of versioning of documents; lack of common collaboration processes and tools between partners; lack of procedures for ad hoc partner invitation and data sharing; difficulties in tracking and planning. These bottlenecks result in problems in the coordination of tasks, sharing and securing of information, and managing the state of work.

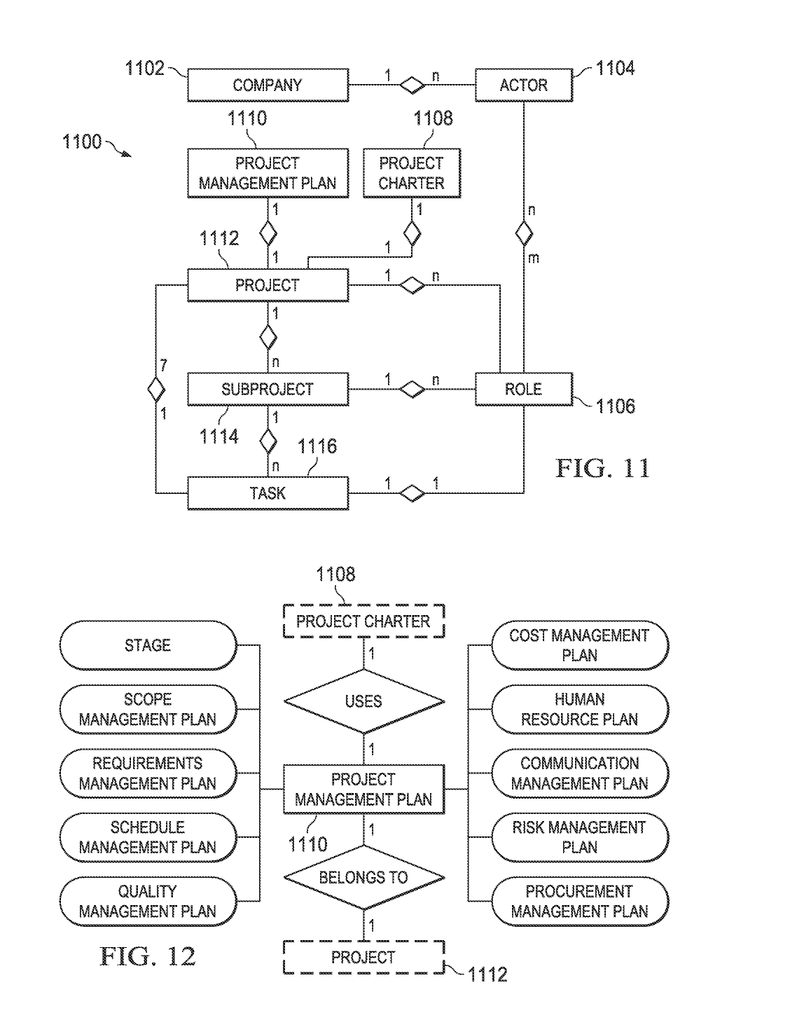

Referring now to FIGS. 11-22 implementations of the present disclosure will be discussed in further detail. FIGS. 11-19 depict example artifacts. FIGS. 20-22 depict example processes.

In view of at least the motivating example discussed above, implementations of the present disclosure provide a tool that can resolve bottlenecks and other issues in collaborative projects. In some examples, implementations of the tool can be provided as one or more computer-executable programs that can be executed using one or more computing devices. Implementations of the tool of the present disclosure provide an artifact-centric approach, which helps to combine project management and its execution. In general, the artifact-centric approach is suitable to support project structures in distributed environments, supports multiple inheritance and dependencies, contains a solution for defining roles and actors, and provides for easy communication between different stakeholders.

In some examples, the artifact-centric approach presents an artifact as a process, which can be defined by a lifecycle using a flow paradigm. Such process artifacts can be grouped and linked at a macro-level as a part of a multi-level parent-child hierarchy, where lifecycles of the process artifacts can be interconnected. In some examples, apart from having several process artifacts at one level, each individual process can contain a number of child processes. A child process plays an important role in the lifecycle of the parent, as it can also cause its lifecycle events. The communication between different process artifacts can be accomplished through synchronization points and internal message action items. This method allows the support of different types of structures, in particular project structures.

In some examples, each process artifact is characterized by accompanied data. However, the data can be presented by references instead values. This provides flexibility when designing distributed systems. In some examples, a process artifact lifecycle can be controlled and manipulated either by other process artifacts and/or by an actor from outside of the system. Such an actor can include, for example, an agent system or an external user (e.g., a partner participating in a collaboration). In some examples, a message can be sent to the actor and an answer is expected of the actor in order to continue the progress of the workflow. This mechanism enables the “outside world” to be informed about steps to be performed to continue moving towards the goal.

In some examples, the involvement of external partners into the lifecycle events of a process artifact can be achieved through an assignment procedure. In some examples, each process artifact can be assigned to partners using a role fulfillment model. Through use of the role fulfillment model binding of actors to roles can be done in run-time (i.e., during the collaboration) in an ad-hoc manner.

Implementations of the present disclosure can include example steps of discovery of business artifacts, design of artifact schemas, and design of an operational model around the business artifacts. In some examples, during the discovery of business artifacts, key business entities and basic relationships between them can be provided. In some examples, a top-down approach is followed and the motivating example, discussed above, can provide a basis for identification of the artifacts. In some examples, during design of artifact schemas, the data attributes important to the identified artifacts can be analyzed. Next, focus can be turned to a logical schema and description of the macro-picture. After the operational model for the business process is ready, the sharing concept is applied.

In some implementations, to define business artifacts, a top-down approach is used to search for the artifacts, the manipulation of which is meaningful for the underlying business processes. Taking into a consideration that the collaboration involves at least two partners (e.g., companies) that affect the overall business processes, an initial artifact can include a company artifact. In the motivating sample discussed above, activities important for the OEM and the Integrator in order to achieve a common goal were addressed. The main operational goal is to successfully complete the project initiated by the OEM. Consequently, it can be provided that the goals of the project are the focus of the business processes. However, the Integrator can also create a project, which is derived from a task delegated by the OEM. The project itself can be presented by a number of attributes, such as time, scope and cost. Accordingly, another artifact is a project artifact.

In view of the motivating example, the project usually involves too many activities to be considered as one package. Consequently, the project can be divided into a number of sequential subprojects, and one or more subproject artifacts can be provided. A subproject is similar to a project in that it has its own scope and time line. However, a subproject is different from a project in the organizational procedures needed to initiate the subproject artifact, as well as corresponding attributes. A project involves the initiation phase, which considers a business environment, a stakeholder analysis, a budget, and the like. A subproject, on the other hand, does not have these characteristics and presents a holder for the set of activities leading to measurable goals contributing into the project success. While subprojects logically divide a project into measurable parts of work, they are still big enough for a straightforward execution.

By making a hierarchical decomposition, or a work break down structure based on deliverables (work packages), a number of tasks that are ready to be assigned and executed can be defined. Consequently, a task artifact is provided. Execution of the project overall and tasks in particular is impossible without human resources assigned to them. Consequently, an actor artifact and a role artifact are provided. An actor artifact represents a human resource, while a role artifact defines the requirements for actors. Success of the project is impossible without a well-defined project charter and a project management plan (PMP), which can be used to set priorities straight and to define the path to achieve the goals.

An example relationship 1100 between the above-discussed artifacts is presented in FIG. 11. In the example of FIG. 11, a company artifact 1102, an actor artifact 1104, a role artifact 1106, a project charter artifact 1108, a project management plan (PMP) artifact 1110, a project artifact 1112, a sub-project artifact 1114, and a task artifact 1116 are provided. In some examples, the company artifact 1102 can be associated with one or more actor artifacts 1104. In some examples, each actor artifact 1104 can be associated with one or more role artifacts 1106. In some examples, the project charter artifact 1108 and the PMP artifact 1110 can each be associated with the project artifact 1112. In some examples, the project artifact 1112 can be associated with one or more sub-project artifacts 1114, and each sub-project artifact 1114 can be associated with one or more task artifacts 1116. In some examples, the project artifact 1112 can be associated with one or more role artifacts 1106. In some examples, each sub-project artifact 1114 can be associated with one or more role artifacts 1106. In some examples, each task artifact 1116 is associated with a respective role artifact 1106.

Implementations of the present disclosure further provide for the design of artifact schemas. In some examples, key data is outlined and an information model is presented for each artifact. FIGS. 12 and 13 respectively depict a PMP artifact 1110 and a project charter artifact 1108. In some examples, the creation of a project charter is performed during the initiation stage of the project and the project charter artifact serves as an input for the PMP. In some examples, the project charter authorizes responsible actors to do the work, as providing an initial overview on expected time, cost and scope constraints. The project charter also defines stakeholders and their interest in the outcomes of the project. In some examples, the project charter artifact is a necessary document for an official start of the project.

In some examples, after the project charter is finished and approved by sponsors, a project manager (e.g., an authorized person defined in the project charter) develops a PMP. In some examples, a PMP can be defined as “a formal, approved document used to guide both project execution and project control.” In some examples, the PMP includes a plurality of subsidiary plans. Example subsidiary plans can include: scope, requirements, schedule, cost, quality, human resource, communications, risk and procurement plans. In some examples, the subsidiary plans guide the stakeholders to successfully achieve the goals.

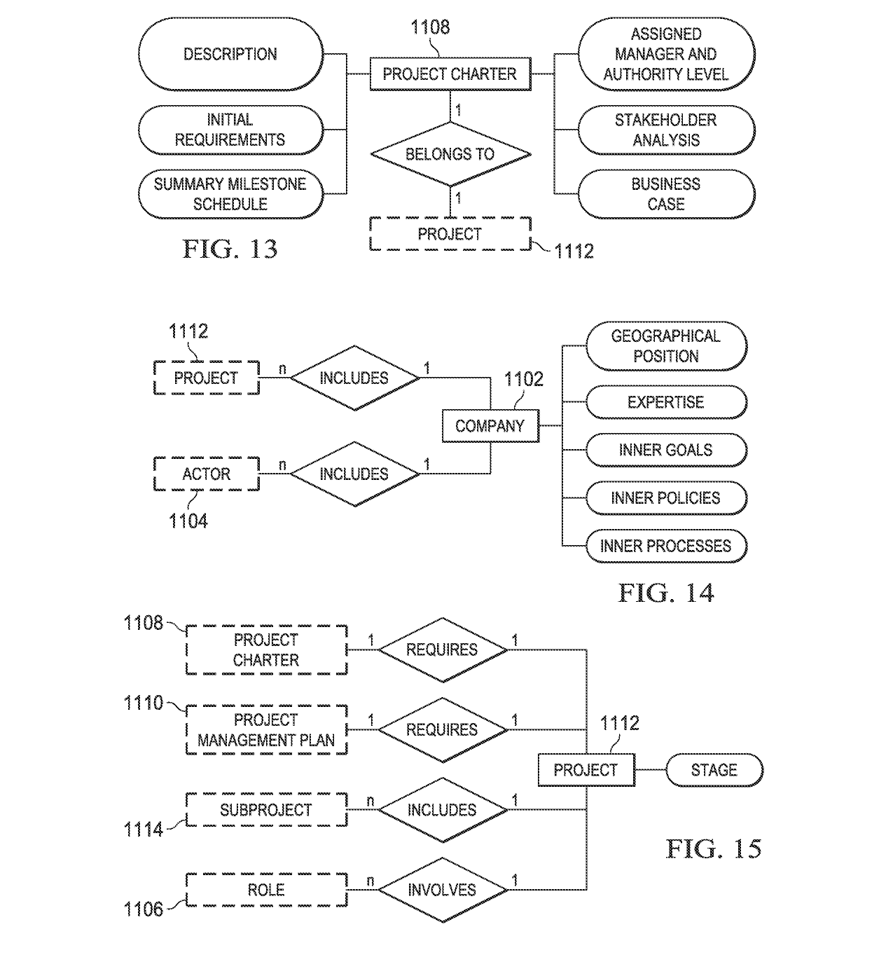

In some examples, a company artifact 1102 affects the nature of the collaborative processes, as it defines geographical dispersion of partners, inner policies and goals as well as expertise owned by the company. An example information model of the company artifact is depicted in FIG. 14. In some examples, a company artifact is one of the background artifacts, which presents on-going information to be used by other entities.

In some examples, a project artifact 1112 is a complex entity, which requires and relies on the existence of other artifacts. For example, the project artifact can rely on a project charter artifact 1108, in which a description, a purpose and other necessary preliminary data is outlined, a PMP artifact 1110, one or more sub-project artifacts 1114, and one or more role artifacts 1106. An example information model of the project artifact is depicted in FIG. 15. In some examples, the lifecycle of the project can include example steps of: initiating, planning, executing, monitoring and controlling, and closing.

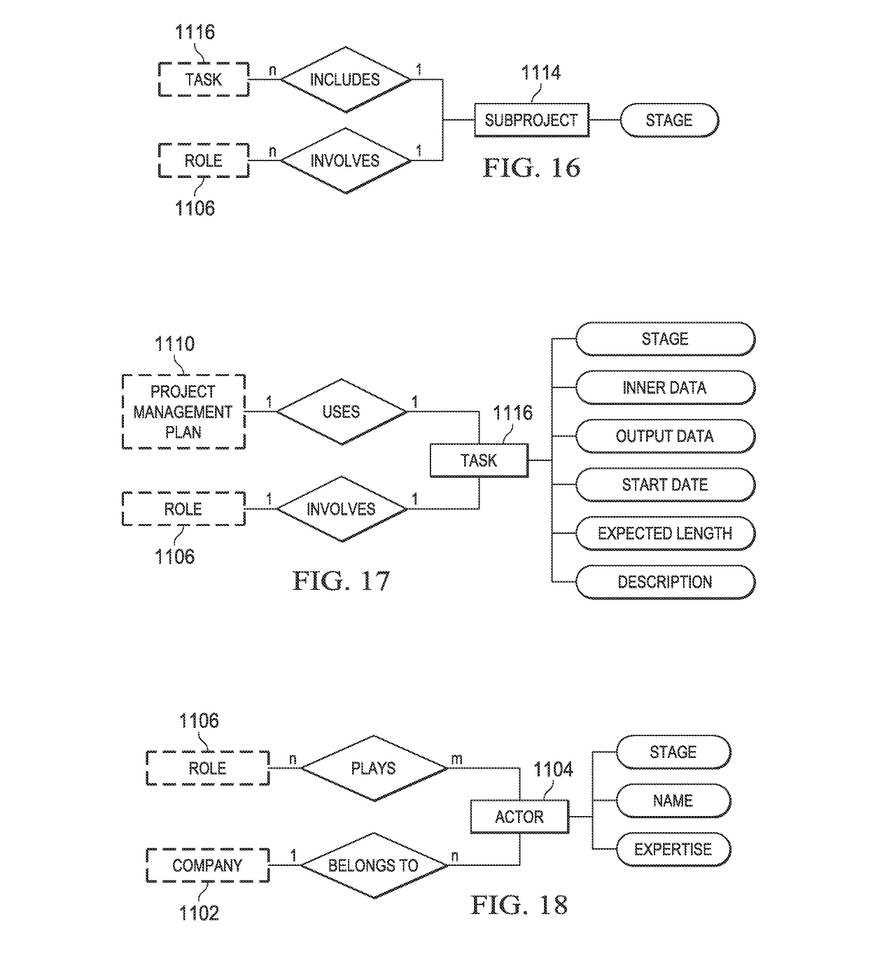

In some examples, and similar to the project artifact, a sub-project artifact 1114 is linked to the list of tasks that are to be performed in order to achieve the goals of the sub-project. A sub-project artifact can also reference roles that are needed for its execution. An example information model of the sub-project artifact is depicted in FIG. 16.

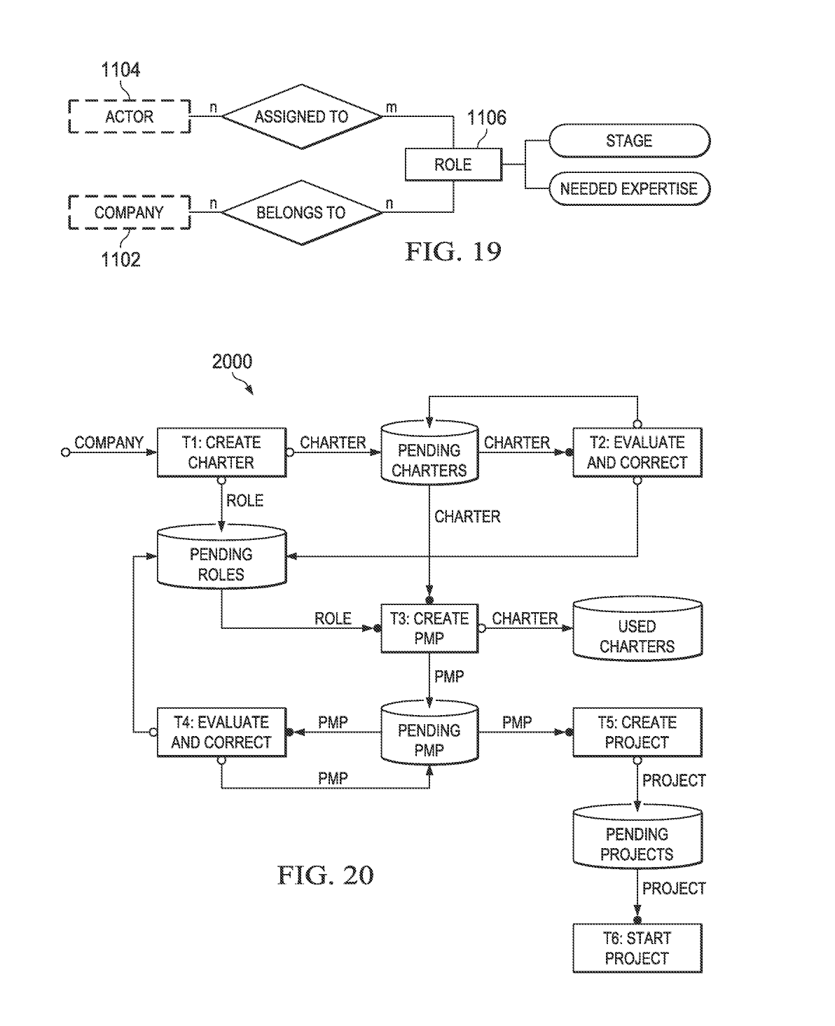

In some examples, a task is the smallest segment of the work that leads to creation of a deliverable. A task can include an associated a role that is connected to an actor responsible for execution of the task. The work on the task is done according to the PMP. An example information model of the task artifact is depicted in FIG. 17. In some examples, an actor and a role are two entities closely connected to each other. While actors can include employees, real people, who hold some expertise, roles describe expected behavior, rights and responsibilities. Consequently, a task can be described based on a role needed for execution of the task. By assigning an appropriate actor to this role, an employee (actor) is provided with rights and instructions to perform the task. These artifacts, actor artifact and role artifact, also belong to the group of background artifacts. Example information models of the actor artifact and the role artifact are depicted in FIGS. 18 and 19, respectively.

Referring now to FIG. 20, an example operational model 2000 for the formal initiation of a project is depicted. In some examples, the goal of the operational model is to describe a sequence of creation and starting of a project. In some examples, artifacts participating in this business process include a project charter artifact, a PMP artifact, a company artifact, a role artifact and a project artifact. For example, the role of the authorized manager for the project is defined in the project charter. The person, who accepted this role, is responsible for the creation of the PMP. After the PMP has been prepared, the project artifact is created and the start of the project is initiated.

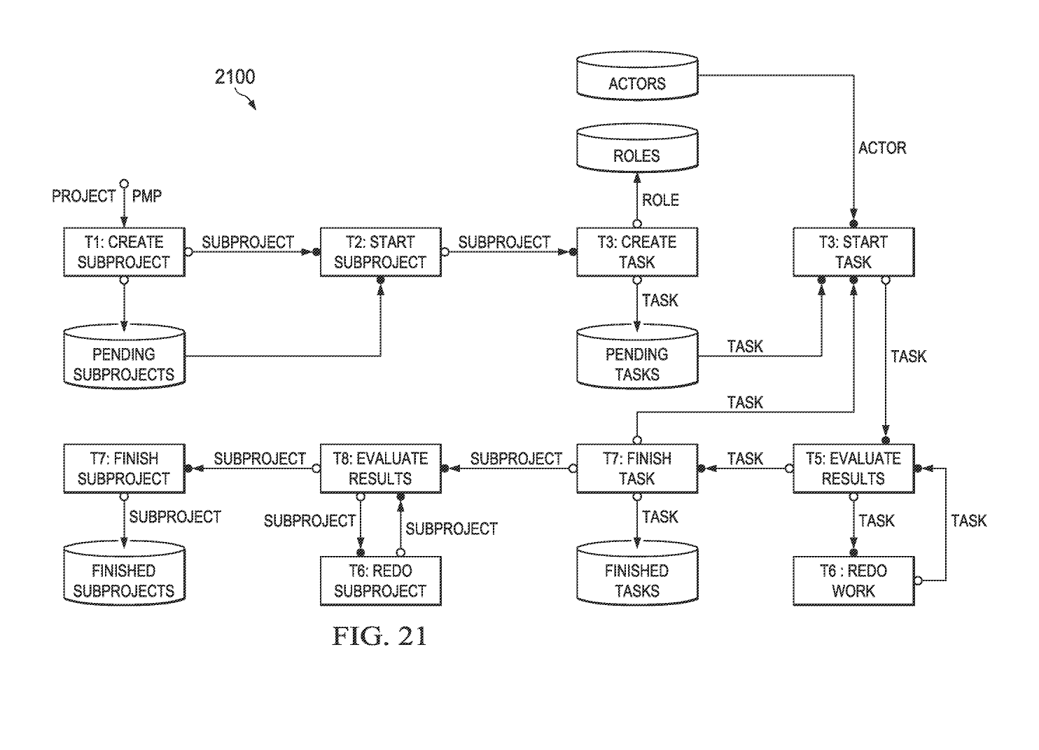

Referring now to FIG. 21, an example operational model 2100 describing execution of the sub-projects and tasks is depicted. In some examples, the primary goal is to show a workflow of how sub-projects and the tasks are processed.

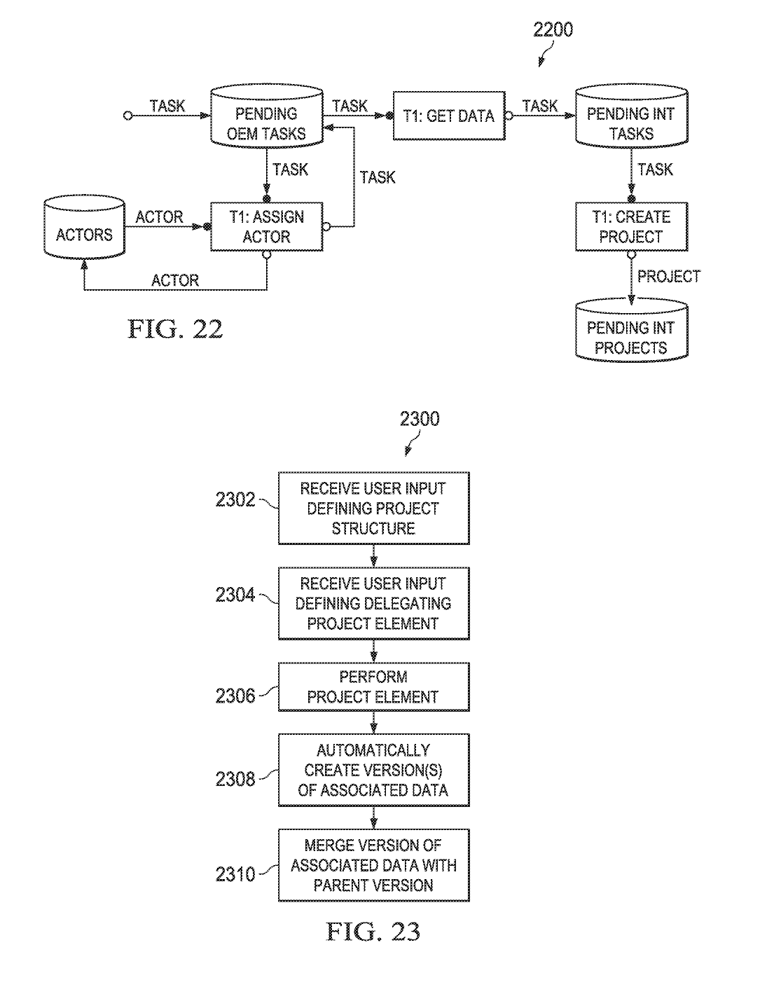

As depicted in FIG. 11, a connection between a task artifact 1116 and a project artifact 1112 can be provided. This can be particularly relevant when a task is big enough and it is evolving into a new project taking the input data and references to the expected output parameters. Thus, a new task is treated as a reason for creating a project based on the new task. Although such situation can happen internally, a more interesting case is when one company (e.g., the OEM in the motivating example) delegates a task to another company (e.g., the Integrator). After the Integrator accepts the task and receives access to input data, the Integrator can manually perform requested calculations, for example, and can send the data back to the OEM. However, when the task is broad enough and involves a lot of resources, performing the task in a single step might not be possible. Consequently, the task can be transformed into a number of activities and can be presented as a new project. Accordingly, after the Integrator has accepted the task and has received access to the input data, the Integrator can create a local project intended to be used as a placeholder for the given assignment. FIG. 22 depicts such a process 2200.

Further detail and relevant information regarding implementations of the present disclosure are provided in the Masters Thesis, which is expressly incorporated herein by reference in the entirety for all purposes, as noted above.

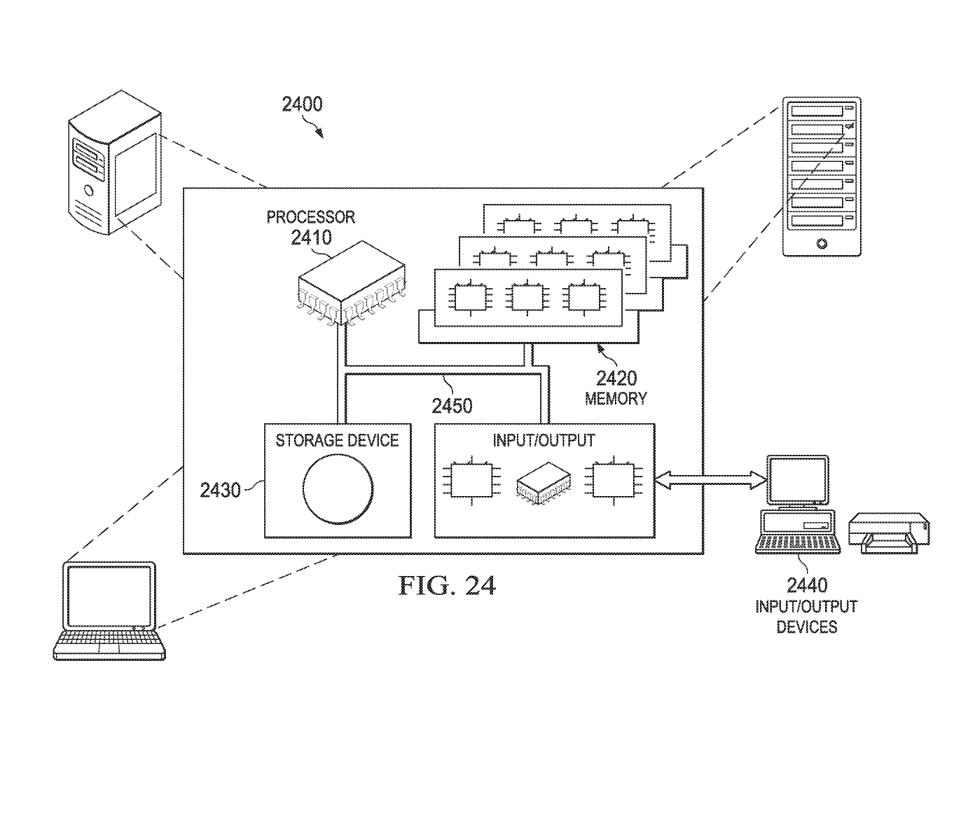

FIG. 23 depicts an example process 2300 that can be executed in accordance with implementations of the present disclosure. In some implementations, the example process 2300 can be executed to provide support for engineering collaboration between partners. In some examples, the example process 2300 can be provided by one or more computer-executable programs that are executed by one or more computing devices. In some examples, the example process 2300 can be provided as part of a computer-executable collaboration tool. In some examples, a computer-executable collaboration tool can be provided in a client-server architecture. For example, user interfaces can be provided on one or more client computing devices for receiving user input. The user input can be transmitted to one or more server devices, which can process the user input as discussed herein.

First user input is received from a first partner (e.g., a customer) (2302). In some examples, the first user input defines a project structure of a collaborative engineering project. In some examples, the project structure includes project elements, each project element having an embedded process therein that supports data sharing and process-based collaboration between partners (e.g., as discussed with reference to, and depicted in FIGS. 8 and 10). Example project structures are discussed above with reference to FIGS. 3A, 3B and 9. Second user input is received from the first partner (2304). In some examples, the second user input indicates delegation of a project element to a second partner (e.g., a supplier, an integrator), the project element having associated data.

The project element is performed by the second partner (2306). During performance of the project element by the second partner, one or more versions of the associated data are automatically created based on a respective embedded process (2308). In some examples, the one or more versions of the associated data are controlled by the second partner. Upon completion of the project element, a version of the associated data is merged with a parent version of the associated data (2310). In some examples, the parent version of the associated data is controlled by the first partner.

Although not depicted in FIG. 23, the example process 2300 can include additional actions. In some examples, third input is received from the second partner. In response to the third input, a project is provided. In some examples, the one or more versions of the associated data are associated with the project, and the project is owned by the second partner, such that the second partner controls access to the one or more versions of the associated data. This is discussed in further detail herein with reference to project-to-partner delegation.

Referring now to FIG. 24, a schematic diagram of an example computing system 2400 is provided. The system 2400 can be used for the operations described in association with the implementations described herein. For example, the system 2400 may be included in any or all of the server components discussed herein. The system 2400 includes a processor 2410, a memory 2420, a storage device 2430, and an input/output device 2440. The components 2410, 2420, 2430, 2440 are interconnected using a system bus 2450. The processor 2410 is capable of processing instructions for execution within the system 2400. In one implementation, the processor 2410 is a single-threaded processor. In another implementation, the processor 2410 is a multi-threaded processor. The processor 2410 is capable of processing instructions stored in the memory 2420 or on the storage device 2430 to display graphical information for a user interface on the input/output device 2440.

The memory 2420 stores information within the system 2400. In one implementation, the memory 2420 is a computer-readable medium. In one implementation, the memory 2420 is a volatile memory unit. In another implementation, the memory 2420 is a non-volatile memory unit. The storage device 2430 is capable of providing mass storage for the system 2400. In one implementation, the storage device 2430 is a computer-readable medium. In various different implementations, the storage device 2430 may be a floppy disk device, a hard disk device, an optical disk device, or a tape device. The input/output device 2440 provides input/output operations for the system 2400. In one implementation, the input/output device 2440 includes a keyboard and/or pointing device. In another implementation, the input/output device 2440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for supporting engineering collaboration between partners, the method being executed by one or more processors and comprising:
receiving, by the one or more processors, first user input from a first partner, the first user input defining a project structure of a collaborative engineering project, the project structure comprising project elements, each project element having an embedded process therein that supports data sharing and process-based collaboration between partners; and
receiving, by the one or more processors, second user input from the first partner, the second user input indicating delegation of a project element to a second partner, the project element having associated data, wherein:
during performance of the project element by the second partner, one or more versions of the associated data are automatically created based on a respective embedded process, the one or more versions of the associated data being controlled by the second partner, and
upon completion of the project element, a version of the associated data is merged with a parent version of the associated data, the parent version of the associated data being controlled by the first partner.

2. The method of claim 1, wherein, in response to receiving the second user input indicating delegation of the project element, automatically copying the parent version of the associated data to provide an initial version of the associated data based on the respective embedded process, the parent version of the associated data being controlled by the first partner, and the initial version of the associated data being controlled by the second partner.

3. The method of claim 1, wherein, in response to completion of the project element, the second partner publishes the version of the associated data.

4. The method of claim 1, wherein, during performance of the project element, the version of the associated data is automatically created based on the respective embedded process and replaces a previous version of the associated data.

5. The method of claim 1, further comprising:
receiving, by the one or more processors, third input, the third input being provided by the second partner; and
providing, in response to the third input, a project, the one or more versions of the associated data being associated with the project, and the project being owned by the second partner, such that the second partner controls access to the one or more versions of the associated data.

6. The method of claim 1, wherein the one or more versions of the associated data are stored in a data repository associated with the second partner.

7. The method of claim 1, wherein, upon completion of the project, the version of the associated data is deleted from a data repository associated with the second partner.

8. The method of claim 1, wherein the project elements comprise a project, one or more sub-projects, and one or more tasks.

9. The method of claim 1, wherein the associated data comprises one or more artifacts that can be modified by the second partner.

10. The method of claim 1, wherein the associated data comprises one or more discrete data values determined by the second partner.

11. The method of claim 1, wherein the parent version of the associated data is stored in a data repository of the first partner.

12. The method of claim 1, wherein the project element comprises a plurality of sub-elements having a hierarchical structure, wherein version data associated with a child sub-element is merged with version data associated with a parent sub-element upon completion of the child sub-element.

13. The method of claim 12, wherein the plurality of sub-elements comprises a plurality of sub-element groups, each sub-element group corresponding to a concept.

14. The method of claim 12, wherein the plurality of sub-elements comprises one or more sub-projects and one or more tasks.

15. A non-transitory computer-readable storage medium coupled to one or more processors and having instructions stored thereon which, when executed by the one or more processors, cause the one or more processors to perform operations for supporting engineering collaboration between partners, the operations comprising:
receiving first user input from a first partner, the first user input defining a project structure of a collaborative engineering project, the project structure comprising project elements, each project element having an embedded process therein that supports data sharing and process-based collaboration between partners; and
receiving second user input from the first partner, the second user input indicating delegation of a project element to a second partner, the project element having associated data, wherein:
during performance of the project element by the second partner, one or more versions of the associated data are automatically created based on a respective embedded process, the one or more versions of the associated data being controlled by the second partner, and
upon completion of the project element, a version of the associated data is merged with a parent version of the associated data, the parent version of the associated data being controlled by the first partner.

16. A system, comprising:
a computing device; and
a computer-readable storage device coupled to the computing device and having instructions stored thereon which, when executed by the computing device, cause the computing device to perform operations for supporting engineering collaboration between partners, the operations comprising:
receiving first user input from a first partner, the first user input defining a project structure of a collaborative engineering project, the project structure comprising project elements, each project element having an embedded process therein that supports data sharing and process-based collaboration between partners; and
receiving second user input from the first partner, the second user input indicating delegation of a project element to a second partner, the project element having associated data, wherein:
during performance of the project element by the second partner, one or more versions of the associated data are automatically created based on a respective embedded process, the one or more versions of the associated data being controlled by the second partner, and
upon completion of the project element, a version of the associated data is merged with a parent version of the associated data, the parent version of the associated data being controlled by the first partner.
